(19) United States
(12) Patent Application Publication
(10) Pub. No.: US 2014/0069888 A1
(43) Pub. Date: Mar. 13, 2014

(54) Baby bottle sleeve

(71) Applicant: MAPA GmbH, Zeven (DE)

(72) Inventors: Bodo Warden, Viersen (DE); Sarah-Dimple Dass, Hamburg (DE)

(73) Assignee: MAPA GmbH, Zeven (DE)

(21) Appl. No.: 14/021,643

(22) Filed: Sep. 9, 2013

(30) Foreign Application Priority Data
Sep. 12, 2012 (DE) 20 2012 008 744.4

(51) Int. Cl. A61J 9/08

(52) U.S. Cl. CPC A61J 9/08
USPC 215/386

(57) ABSTRACT

A baby bottle sleeve comprising a cylindrical sleeve made of an elastomer material for holding a baby bottle having a top opening for a top end region of a baby bottle extending out of the sleeve, and a cutout extending downward from the edge of the top opening that can be opened for inserting and removing a baby bottle, and at least one closable and openable closing means that, in a closed state, fixes the cutout in a closed position and releases the cutout in an open state so that it can be opened.

### CROSS-REFERENCE TO RELATED APPLICATIONS

This Utility Application claims priority to DE 20 2012 008 744.4 filed on Sep. 12, 2012, the entire contents of which are incorporated by reference.

### STATEMENT REGARDING FEDERALLY SPONSORED RESEARCH

Not applicable

### BACKGROUND OF THE INVENTION

The invention relates to a baby bottle sleeve.

Baby bottles made of glass or plastic having a bottle teat made of latex or a silicone elastomer sealingly fastened to the bottle opening serve to feed small children. Baby bottle sleeves are known that protect baby bottles from damage, make grasping more pleasant and secure or prevent heat loss.

DE 297 18 321 U1, the entire contents of which is incorporated herein by reference, describes a soft feeding bottle cover for liquid baby and small child food that is soft in nature and for example consists of silicone, rubber, foam and other materials suitable for infants and small children. The cover is in the shape of a sleeve that can be pulled over the baby bottle.

CN 202014974 U, the entire contents of which is incorporated herein by reference, relates to a protective sleeve made of silicone rubber for a drinking bottle made of glass that comprises a soft sleeve which is pulled over the body of a glass bottle. The shape of the soft sleeve is adapted to the shape of the glass bottle. The top part of the soft sleeve is provided with a passage for the glass bottle for inserting it into the sleeve. The bottom part of the sleeve is equipped with a support base that covers the bottom of the glass bottle. The sleeve is thermally insulating and non-slipping and does not become viscous when heated. On the perimeter, the protective sleeve is provided with a window. It is laborious to place the protective sleeve on a baby bottle and remove it from the baby bottle since the elastic and non-slip material must be spread and pulled over the baby bottle. If the bottle breaks, shards or other fragments can exit the window.

U.S. Pat. No. 8,132,683 B2, the entire contents of which is incorporated herein by reference, describes a protective sleeve made of an elastic material having a cup for receiving the bottom end of a bottle and two loops that are placed on different sides around the neck of the bottle. The elastic material is for example a silicone elastomer, thermoplastic elastomer or latex. Attaching and removing the loops requires an increased effort. This can overstretch the loops so that the protective sleeve does not lie tightly against the baby bottle. The thicker material at the intersections of the loops can be annoying during grasping.

### BRIEF SUMMARY OF THE INVENTION

Against this background, the objective of the invention is to provide a more user-friendly baby bottle sleeve.

This object is achieved by a baby bottle sleeve having the features of claim 1. Advantageous embodiments of the baby bottle sleeve are specified in the dependent claims.

The baby bottle sleeve according to the invention comprises a cylindrical sleeve made of an elastomer material for holding a baby bottle having a top opening for a top end region of a baby bottle extending out of the sleeve, and a cutout extending downward from the edge of the top opening that can be opened for inserting and removing a baby bottle, and at least one closable and openable closing means that, in a closed state, fixes the cutout in a closed position and releases the cutout in an open state so that it can be opened.

The baby bottle sleeve according to the invention has a sleeve made of elastomer material that can be placed on a baby bottle under elastic initial tension. The sleeve preferably fits the external shape of baby bottle. The baby bottle is inserted and removed through the top opening in the sleeve. The sleeve has a cutout proceeding from the top opening which makes it easier to insert or remove the baby bottle. The cutout is opened to insert and remove the baby bottle which thereby enlarges the top opening for the baby bottle. At the same time, opening the cutout causes the sleeve to press less tightly against the outer perimeter of the baby bottle when inserting the baby bottle. Consequently, the baby bottle sleeve with the open cutout can be placed on and removed from the baby bottle with less friction resistance than a conventional, tightly seated baby bottle sleeve. In order to insert and remove the baby bottle, the closing means is opened so that the cutout can be opened. When the baby bottle is inserted, the cutout is closed and the closing means are closed so that they fix the cutout in a closed position. The sleeve then lies tightly against the baby bottle so that it cannot accidentally fall out. The invention promotes the particularly tight contact of the sleeve against the baby bottle. Wrinkles and other accumulated material are avoided. The close fitting sleeve protects the baby bottle from breaking and dampens impact. In case of breakage, the sleeve retains shards and other fragments. The risk of injury is reduced. The baby bottle sleeve is particularly advantageous for easily breakable bottles made of glass or brittle plastic.

The object is also achieved by a baby bottle sleeve described herein.

The baby bottle sleeve according to the invention comprises a cylindrical sleeve made of a silicone elastomer for holding a baby bottle with a top opening for a top end region of a baby bottle extending out of the sleeve and a window region in which the wall thickness of the sleeve is reduced relative to the wall thickness in the neighboring regions of the sleeve, and that is polished on the outer surface.

With the sleeve made of silicone elastomer, the baby bottle sleeve according to the invention lies tightly against a baby bottle and protects it from breaking. In addition, the silicone elastomer dampens arising impacts. Shards and other fragments are retained by the sleeve. It is particularly advantageous that the sleeve does not have a window opening through which the fragments can exit. Nevertheless, an observer can discern the content of the baby bottle sleeve through the window region of the baby bottle sleeve, because the window region is semiopaque (translucent) due to its reduced wall thickness and polished outer surface, or even non-opaque or respectively see-through (transparent). Darker and lighter regions are visible through a translucent window region. That which is behind a transparent window region can be discerned with relative clarity. A translucent or transparent window region allows the level to be checked in particular, and a transparent window region allows the content of a baby bottle (such as the type of beverage like milk or tea) to be checked. By appropriately selecting the wall thickness and polishing the outer surface of the window region, it can even be designed to be as clear as glass. The regions of the sleeve neighboring the window region are contrastingly less transparent than the window region due to their greater wall thickness and lack of a polished surface. They are preferably slightly translucent (cloudy) or even completely opaque.

The wall thickness in the window region is preferably 0.5 to 1.5 mm and more preferably 1 mm. In the neighboring regions, the wall thickness is preferably 0.75 to 3 mm and more preferably 2 mm.

According to a preferred embodiment, the baby bottle sleeve has the cutout and closing means as well as the window region.

According to another embodiment, the sleeve has a waist. The waist makes it easier for the sleeves to tightly rest against the waisted baby bottle. This is particularly comfortable when handling a waisted baby bottle.

According to another embodiment, the top edge of the sleeve has a retracted top edge area surrounding the top opening for partially covering the top region of a baby bottle when it is held by the sleeve. With the top edge region, the sleeve partially covers the bottle also at the top so that only its top end region projects out of the sleeve. This securely holds the baby bottle sleeve and better protects it from damage. In addition, the release of fragments is more effectively suppressed.

According to another embodiment, the sleeve has below a base for supporting underneath a baby bottle when it is held by the sleeve. The base is preferably a retracted bottom edge region of the sleeve. According to these embodiments, the base of the bottle is partially or entirely covered by the sleeve. This holds the baby bottle sleeve more securely and better protects it from damage. In addition, the release of fragments is even more effectively suppressed. More preferably, the wall thickness of the sleeve is greater at the retracted bottom edge region. The sleeve with the inserted baby bottle is set down on this edge region, and the increased wall thickness still more effectively dampens impact while setting down. The increased wall thickness at that location is for example 2 to 4 mm, and preferably 3 mm.

According to another embodiment, the closing means has a pair of closing elements that are arranged on first and second edges of the cutout and are connectable to each other to hold the cutout in a closed position. According to another embodiment, the closing elements are button elements. According to a preferred embodiment, the button elements have a button on a first edge of the cutout, and a buttonhole for buttoning the button on a second edge of the cutout. According to another embodiment, the button elements have a button on a first edge of the cutout, and a loop for buttoning the button in a second edge of the cutout. According to another embodiment, the button elements are pushbutton elements of a pushbutton. According to another embodiment, the closing element is a Velcro connection, wherein the two elements of the Velcro connection are arranged on the first and second edges of the cutout. The baby bottle sleeve preferably has only a single pair of closing elements of the aforementioned types. According to another embodiment, the baby bottle has equivalent or different pairs of closing elements of the aforementioned types.

The above embodiments of the closing means consequently make handling the baby bottle sleeve especially easy and obvious.

According to another embodiment, the first and the second edges of the cutout have first and second overlapping regions that can be brought into a position overlapping each other when the feeding bottle is removed from the sleeve, and on which the closing means is arranged. This makes it easier to close the closing means. When the cutout is closed, the sleeve also completely covers the baby bottle in the region of the overlapping regions.

According to a preferred embodiment, a buttonhole of the closing means is arranged in an overlapping region of an edge of the cutout when the first and second overlapping regions are in an overlapping state. This makes it easier to close or open the cutout because the overlapping region with the buttonhole can be pressed from the outside over the overlapping region with the button, or can be pulled off outward therefrom.

According to another embodiment, the closing means is a ring made of an elastomer material that can be elastically stretched and shoved over the sleeve in the region of the cutout when a baby bottle is held by the sleeve.

According to another embodiment, the cutout has a rounding at the base. The rounding can prevent stress peaks at the base of the opened cutout which could cause the sleeve to tear at the base of the cutout.

According to another embodiment, the cutout extends over at least one-half the height of the sleeve, and preferably over at least two-thirds of the height of the sleeve. This makes it possible to open the sleeve wide at the cutout to easily insert or remove a baby bottle.

According to another embodiment, the window region is arranged diametrically opposed to the cutout on one side of the sleeve. According to another embodiment, the window region is strip-shaped and extends in the longitudinal direction of the sleeve. According to another embodiment, the window region has rounded top and bottom window edges and/or linear side window edges.

According to a preferred embodiment, the sleeve of the baby bottle sleeve with the cutout is made from a silicone elastomer, or is manufactured from silicone rubber. The button also preferably consists of a silicone elastomer.

The sleeve is also preferably manufactured as a single part from silicone rubber. The button is preferably manufactured as a single part with the sleeve.

### BRIEF DESCRIPTION OF THE SEVERAL VIEWS OF THE DRAWINGS

The invention is explained in the following in more detail using the attached drawings of an exemplary embodiment. The drawings show:

FIG. 1 A perspective view at an angle from above and from the side of a baby bottle sleeve with a closed cutout;

FIG. 2 A front view of the same baby bottle sleeve;

FIG. 3 A rear view of the same baby bottle sleeve;

FIG. 4 A view from the left side of the same baby bottle sleeve;

FIG. 5 A view from the right side of the same baby bottle sleeve;

FIG. 6 A plan view of the same baby bottle sleeve;

FIG. 7 A view from below of the same baby bottle sleeve;

FIG. 8 A vertical section of the same baby bottle sleeve through the cutout;

FIG. 9 A front view of the same baby bottle sleeve when the cutout is open;

FIG. 10 A perspective view at an angle from above and from the side of the same baby bottle sleeve with an inserted baby bottle;

FIG. 11 A front view of the same baby bottle sleeve with an inserted baby bottle;

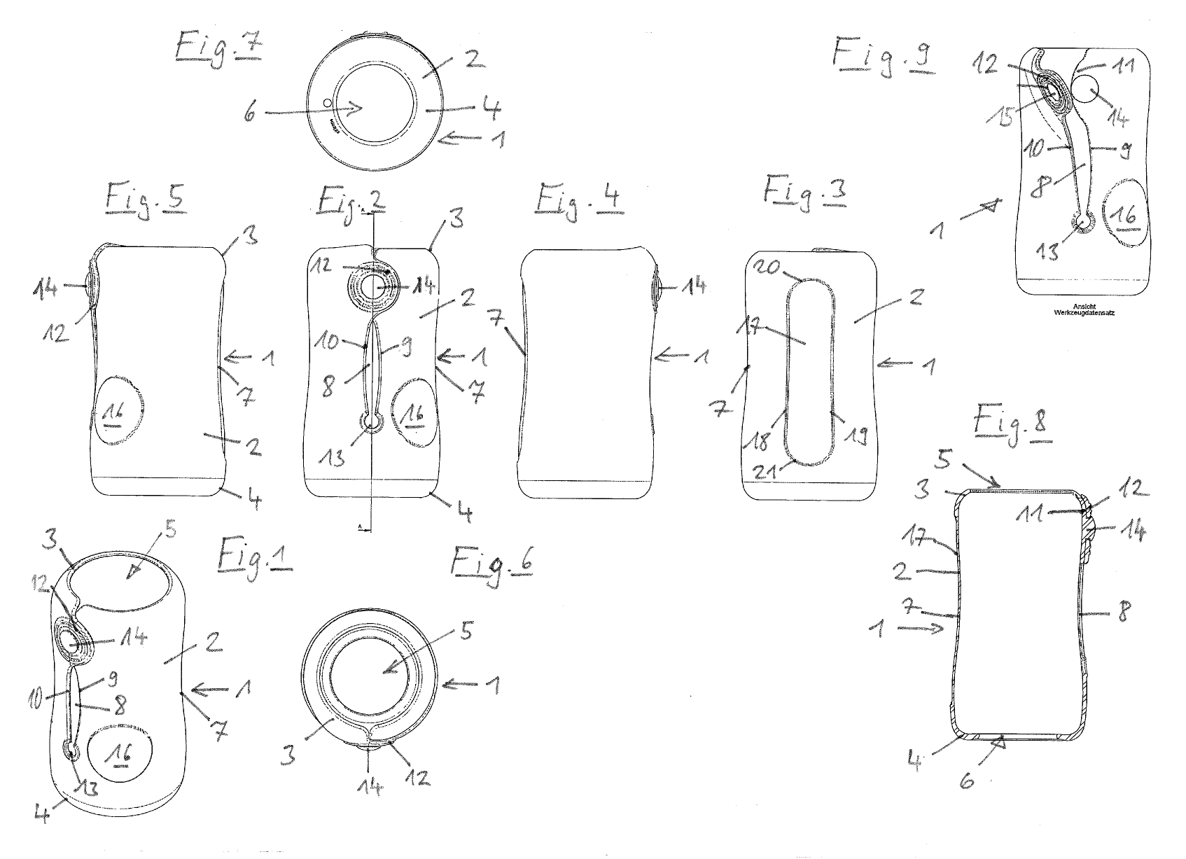

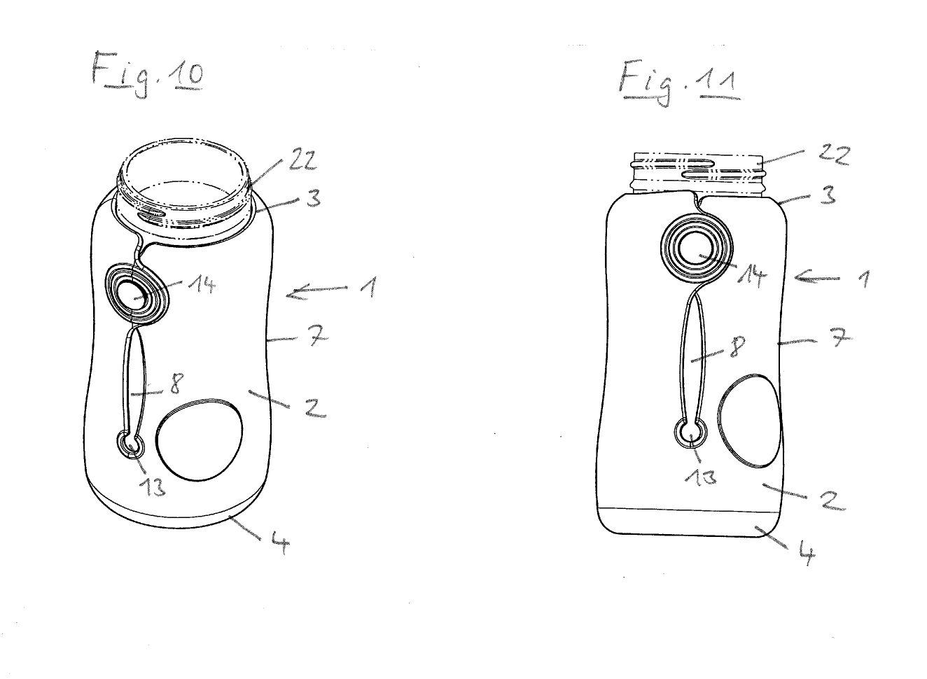

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

In the present application, the designations “top” and “bottom” relate to an alignment of the baby bottle sleeve with its longitudinal axis aligned in the vertical direction, wherein the top opening is arranged at the top for the top end region of the feeding bottle to pass through, and the base of the cutout is arranged at the bottom.

The baby bottle sleeve 1 has a substantially cylindrical sleeve 2 having a retracted top edge region 3 at the top and a retracted bottom edge region 4 at the bottom. The retracted top edge region 3 encloses a top opening 5. The retracted bottom edge region 4 forms a base with a floor opening 6.

In addition, the sleeve 2 has a waist 7 in the middle region.

Proceeding from the top opening 5, a cutout 8 extends in the sleeve 2 in the longitudinal direction of the sleeve 2. The cutout 8 is delimited on both sides by first and second edges 9, 10. The first and second edges 9, 10 have first and second overlapping regions 11, 12 in the top region of the cutout 8. At the bottom, the cutout 8 has a rounding 13.

In the overlapping regions, the edges 9, 10 respectively bulge outward. An outwardly projecting button 14 is seated in the first overlapping region 11, and the second overlapping region 12 has a buttonhole 15 into which the button 14 can be buttoned. The buttonhole 15 is circular and surrounded by concentric beads that make it easier to grip the second overlapping region 12. In an expanding region, the buttonhole 15 gradually expands to the outer surface of the sleeve 2.

Next to the cutout 8, for example on the outside of the sleeve 2, there is an elevation 16 with a circular contour that for example serves to carry a logo.

Opposite the cutout 8, the sleeve has a strip-shaped window region 17 that has longitudinal linear window edges 18, 19, and rounded top and bottom window edges, 20, 21. In the window region 17, the wall of the sleeve 2 is thinner than in the other regions. To accommodate this, the sleeve 2 is recessed in the window region 17 at the outside. On the inside, the transition from the window region 17 to the neighboring regions of the sleeve 2 is smooth. In the exemplary embodiment, the wall thickness in the window region 17 is 1 mm. In the other regions of the sleeve 2, it is 2 mm.

In the window region 17, the sleeve is polished to a high gloss on the outside. Since the window region 17 is formed in a recess in the outside, the polished outside of the window region 17 is more protected than the neighboring regions of the sleeve 2.

The sleeve 2 consists of a silicone elastomer. It is preferably manufactured as a single part, including the button 14, from silicone rubber. The button 14 can alternatively be manufactured separate from the sleeve 2 (e.g. made of plastic or metal) and affixed thereto.

The sleeve 2 is for example dimensioned for a baby bottle with a capacity of 240 mL.

To insert a baby bottle, the buttonhole 15 is pulled off the button 14, and the cutout 8 is opened as shown in FIG. 9. After a baby bottle 22 is inserted, the cutout is closed, and the buttonhole 15 is pressed onto the button 14 as shown in FIGS. 10 and 11. The baby bottle sleeve 1 improves the grip of the baby bottle 22, stabilizes it and protects it from damage. In the case of breakage, it keeps the fragments together. In addition, it can function in an insulating manner.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A baby bottle sleeve comprising a cylindrical sleeve (2) made of an elastomer material for holding a baby bottle (22) having a top opening (5) for a top end region of a baby bottle (22) extending out of the sleeve (2), and a cutout (8) extending downward from the edge of the top opening (5) that can be opened for inserting and removing a baby bottle (22), and at least one closable and openable closing means (14, 15) that, in a closed state, fixes the cutout (8) in a closed position and releases the cutout (8) in an open state so that it can be opened.

2. The baby bottle sleeve comprising a cylindrical sleeve (2) made of a silicone elastomer for holding a baby bottle (22) with a top opening (5) for a top end region of a baby bottle (22) extending out of the sleeve (2) and a window region (17) in which the wall thickness of the sleeve (2) is reduced relative to its wall thickness in the neighboring regions of the sleeve (2), and that is polished on the outer surface.

3. The baby bottle sleeve according to claim 1, wherein the sleeve (2) has a waist (7).

4. The baby bottle sleeve according to claim 1, wherein the top edge of the sleeve (2) has a retracted top edge area (3) surrounding the top opening (5) for partially covering the top region of a baby bottle (22).

5. The bottle sleeve according to claim 1 which has below a base (4) for supporting underneath a baby bottle (22).

6. The baby bottle sleeve according to claim 5, wherein the base is a retracted bottom edge region (4) of the sleeve (2).

7. The baby bottle sleeve according to claim 1, wherein the closing means (14, 15) has a pair of closing elements that are arranged on first and second edges (9, 10) of the cutout (8) and are connectable to each other to fix the cutout (8) in a closed position.

8. The baby bottle sleeve according to claim 7, wherein the closing elements (14, 15) are button elements.

9. The baby bottle sleeve according to claim 8, wherein the button elements (14, 15) have a button (14) on a first edge (9) of the cutout (8), and a buttonhole (15) for buttoning the button (14) in a second edge (10) of the cutout (8).

10. The baby bottle sleeve according to claim 1, wherein the first and the second edges (9, 10) of the cutout (8) have first and second overlapping regions (11, 12) that can be brought into a position overlapping each other when the baby bottle (22) is removed from the sleeve (2), and on which the closing means (14, 15) are arranged.

11. The baby bottle sleeve according to claim 1, wherein the button hole (15) of the closing means is arranged in an overlapping region (12) of an edge (10) of the cutout (8) when the first and second overlapping regions (11, 12) are in an overlapped state.

12. The baby bottle sleeve according to claim 1, wherein the cutout (8) has a rounding (13) at the base.

13. The baby bottle sleeve according to claim 1, wherein the cutout (8) extends over at least one-half the height of the sleeve (2), and preferably over at least two-thirds of the sleeve (2).

14. The baby bottle sleeve according to claim 1, wherein the window region (17) is arranged diametrically opposed to the cutout (8) on one side of the sleeve (2).

15. The baby bottle sleeve according to claim 1, wherein the sleeve (2) consists of a silicone elastomer, wherein the button (14) preferably also consists of a silicone elastomer.

16. The baby bottle sleeve according to claim 15, wherein the sleeve (2) is manufactured as a single part from a silicone rubber, wherein the sleeve (2) and the button (14) are preferably a manufactured as a single part from a silicone rubber.
